(19) United States
(12) Patent Application Publication
(10) Pub. No.: US 2005/0191048 A1
(43) Pub. Date: Sep. 1, 2005

(54) Stereoscopic universal camera apparatus

(75) Inventor: Samer Ramadan, Newfields, NH (US)

Correspondence Address: MESMER & DELEAULT, PLLC, 1 NEW HAMPSHIRE AVE., SUITE 125, PORTSMOUTH, NH, 03801, US

(73) Assignee: MISSION3D LLC, Newfields, NH (US)

(21) Appl. No.: 10/378,253

(22) Filed: Mar. 3, 2003

(51) Int. Cl. G03B 35/00

(52) U.S. Cl. 396/329

(57) ABSTRACT

The present invention relates to a stereoscopic single digital, SLR, APS, Polaroid, disposable, or Point and Shoot camera guiding plate in the form of a slim-base plate with a straight supporting back ridge and a small guide to aid in selecting the distance between two right and left stereo pairs of photos and maintain positioning. This is a simple inexpensive ultra-slim-design plate that does not require the means to support a tripod, or the means to attach a camera to any device or apparatus, this invention works on a tabletop and is meant to provide the basic needs and supports the easiest and simplest form for quality stereoscopic photography.

### TECHNICAL FIELD

The present invention relates to stereoscopic photography and the captures of a matched pair of photos by use of any single lens camera, one photo to represent a right-eye view of the intended subject and another for a left-eye view. These two photographs can then be scanned or downloaded and combined for viewing with various 3 dimensional formats such as Parallel, Cross-eyed viewing, with hand-held viewers, more particularly to a simple slim camera plate and sliding guide apparatus for easily and in the most simplest form accurately capture a stereo pair of photographs of a scene or a subject.

### BACKGROUND ART

Typically, a stereoscopic camera comes with a built-in pair of left and right eye views of a subject and captures two images of a filmstrip for slide viewing. These cameras are old, hard to find or are expensive for use by novices. They do not offer the convenience, ease of use and economy to capture stereoscopic photography by using any camera that is equipped with or without a tripod socket. All existing inventions and products require a threaded socket on the camera to guide the camera on the slide bar in order to capture quality stereoscopic photographs. This creates a problem for a good number of consumers who purchase disposable film cameras or use new smaller digital cameras that does not come equipped with a threaded tripod socket. For these consumers there is no simple inexpensive apparatus that helps them capture quality stereo pair of left and right images in the market. Therefore we felt the need to solve this problem and create an apparatus and design a slim plate with a necessary back-ridge and side guide to allow any consumer to capture quality stereoscopic images without the need to physically attach a camera to any apparatus by use of a tripod threaded socket.

Although several patents of various apparatus have been designed to provide the ability to take a left and right eye view of a scene or a subject as suggested in prior art U.S. Pat. No. 5,809,355 issued Jan. 10, 1997, U.S. Pat. No. 4,768,049, issued Aug. 30, 1988, U.S. Pat. No. 2,791,950, issued May 1957, U.S. Pat. No. 2,279,443, issued April 1942, U.S. Pat. No. 1,371,439, issued Mar. 15, 1921, and U.S. Pat. No. 713,177, issued Nov. 11, 1902, an ordinary camera with only a single capture lens can be used to sequentially expose respective images of the same scene or subject on a pair of adjacent film frames when the camera is in right and left picture-taking positions. A suitable distance between the right and left photo-capture positions is chosen to obtain a matched pair of images that when looked at together through an appropriate stereoscopic viewer shows a stereoscopic 3 dimensional image of the original scene or subject. All come requiring a camera to have a threaded tripod socket and typically having two pre-set locations for locating the camera in the right and left photo-capture positions.

This new stereoscopic apparatus allows for the use on a flat surface and may be used with a tripod but does not require one, as most novice or traveling camera users do not necessarily have access to a tripod. The back ridge could also include a horizontal level to make sure that the flat surface is leveled horizontally as the camera is pointed towards the scene to be photographed. In addition, with the compact slim nature of new digital and mini and micro cameras as opposed to old bulky SLR cameras, today's users expect such adapters to now be very compact and portable. Existing mechanisms in limited shops or on the Internet are too cumbersome, bulky, and not simple enough for the novice consumer and all require the camera to have a threaded socket. Marketability demands and the growing sophistication of various free camera devices led to this creation, a very simplified and easy to use new stereoscopic apparatus specifically targeting novice, beginners and users of all types of cameras.

### SUMMARY OF THE INVENTION

The present invention relates to a stereoscopic plate and sliding guide apparatus plate for any type of camera. This said apparatus allows for the precise positioning of just one single lens camera at each of two specified right/left locations to be selected from a list of pre set locations on the back ridge of the base plate. Two individual left and right eye photographic view representations of a scene or a subject are then captured and stored on a digital camera-recording medium or on a film for further processing, scan or download to a computer or a suitable printer.

Any macro, zoom or wide-angle lens can be used in the process. This stereoscopic camera apparatus mainly consists of a base plate with a rubber pr cork bottom to keep it from prematurely sliding on top of a flat surface; and attached is a sliding guide with the means to slide on the back-ridge of the base-plate to guide the freely placed camera to the proper position. This stereoscopic apparatus is designed to be ultra-compact, slim, highly functional and extremely easy to use for still photography.

### BRIEF DESCRIPTION OF THE DRAWINGS

FIG. 1 shows the slim stereoscopic base plate (FIG. 1.3) ready for use along with the sliding guide (FIG. 1.1) on the back ridge (FIG. 1.2) in the left image capture position on the left side of the distance scale (FIG. 1.4).

FIG. 1.5 shows in dotted lines the bottom of the stereoscopic plate where the rubber (or cork) mat is attached.

FIG. 1.6 shows the right end of the plate where the sliding guide (FIG. 1.1) is to be installed, then slid all the way to the left, where it can no longer go any further because the left end of the stereoscopic plate (FIG. 1.7) is closed, so the sliding guide comes to a stop and does not fall out.

FIG. 2 shows how the sliding guide (FIG. 2.1) is slid onto the back-ridge (FIG. 2.2) attached to the stereoscopic base plate (FIG. 2.3) through the right end (FIG. 2.5) and into a right image capture position.

FIG. 3 shows a side view of the stereoscopic base plate (FIG. 3.1) and the sliding guide (FIG. 3.2) and how the sliding guide fits around the back ridge. FIG. 3.4 shows how the thin rubber or cork mat fits under the base plate as also shown in (FIG. 4.4).

FIG. 5 shows a top view of the stereoscopic base plate and how the sliding guide (FIG. 5.2) is fitted on the back ridge (FIG. 5.3). FIG. 5.4 shows a dotted line to denote the mat placed at the bottom of the stereoscopic base plate.

FIG. 5.5 points to where an optional level vial could be placed.

FIG. 5.6 points to where an optional threaded socket could be placed for use with a tripod.

FIG. 6 shows a side view of how a sample camera is placed on the stereoscopic apparatus.

FIG. 7 shows how a user directs a camera towards the subject to the photographed. The dotted lines shows the first “L” position capturing a left eye view of the subject, then the sliding guide (FIG. 7.2) and camera is slid on the stereoscopic base plate to the “R” to capture a right-eye view of the subject. It also shows how the camera is placed flat against the back ridge (FIG. 7.3) and from the side onto the sliding plate (FIG. 7.2) to keep the camera in a straight position linear position. The distance between the “L” and “R” position is 65 mm or the average distance between two human eyes. However the user has the freedom to select different distances and experiment.

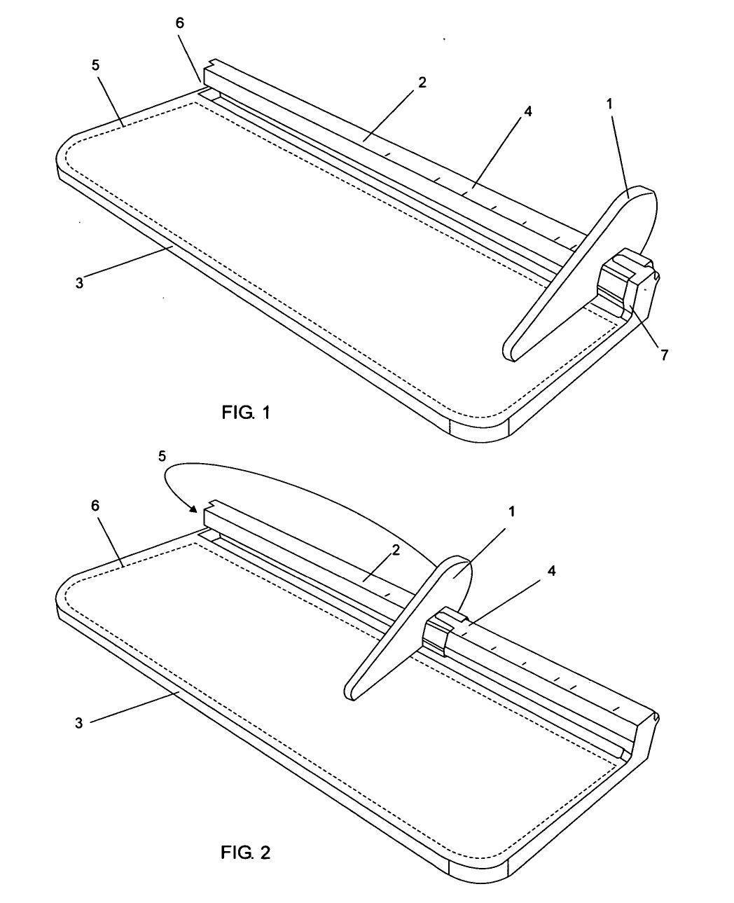

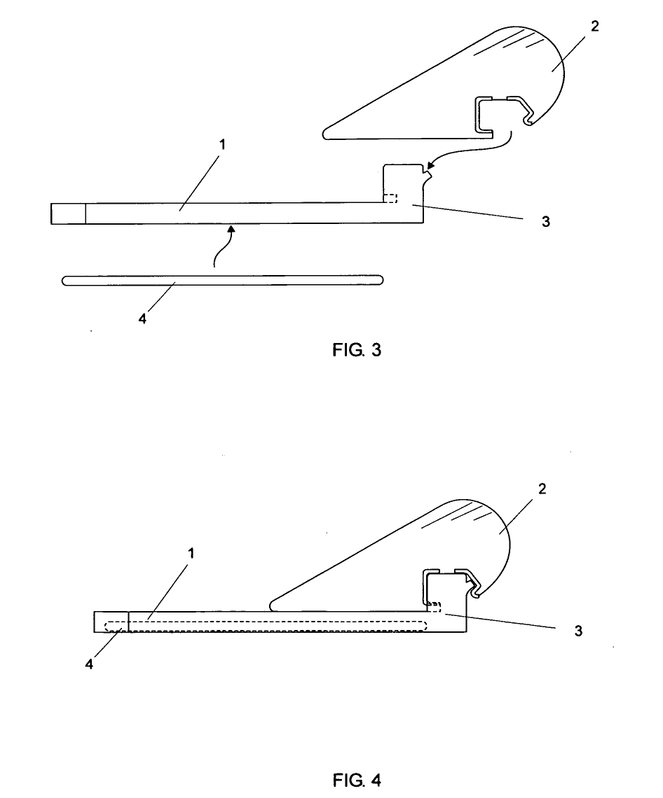

### BEST MODE FOR CARRYING OUT THE INVENTION

Referring to the drawings as sub numbers to the Figure numbers, here's how the Stereoscopic Universal Camera Apparatus is best used:

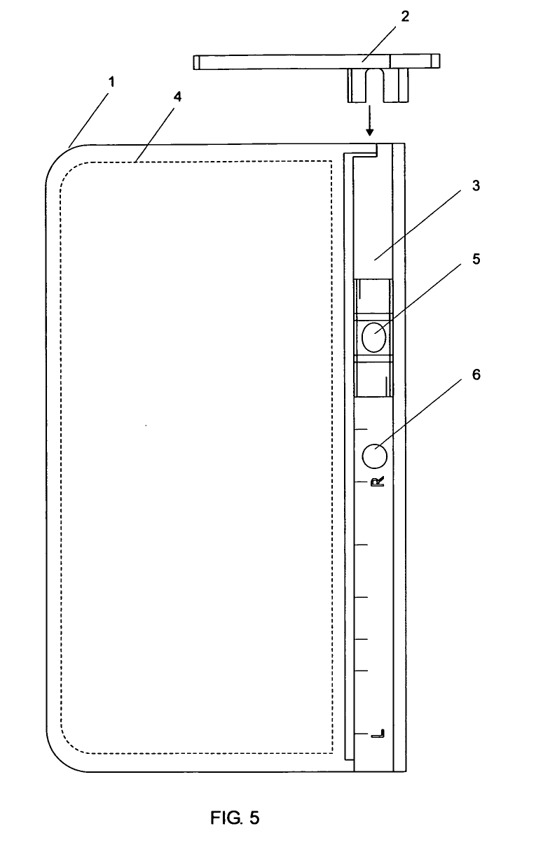

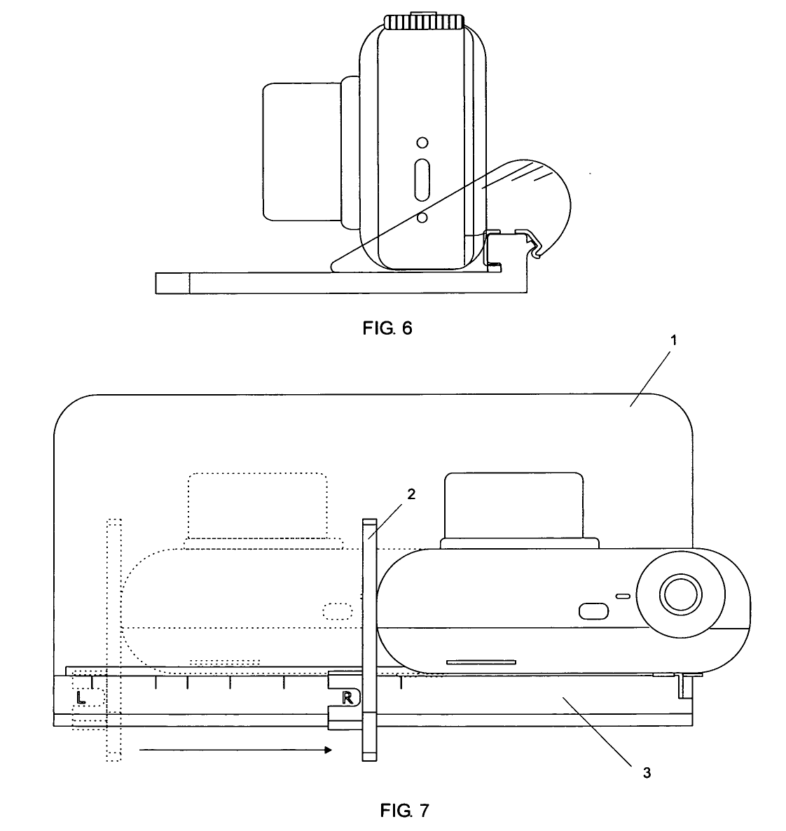

For use with on a flat even surface, the user first attaches the sliding guide as seen in FIG. 5, then places any camera, digital, SLR, APS, Polaroid, point and shoot, disposable, PC camera or any other camera capable of capturing still images right on top of the base plate with the back of the camera towards the back-ridge FIG. 5.3 and the front where the lens is towards the subject to be photographed.

With the sliding guide positioned all the way to the left, and the camera tightly held against the back ridge from the back and against the sliding guide from the left, and with the left hand holding the stereoscopic base plate tightly to the flat surface, the user snap a left-view shot of the intended subject.

After the left shot is captured, the user then slides the camera and the sliding guide to the right while maintaining a grip on the stereoscopic plate tightly onto the flat surface where the base plate is placed to make sure that the camera travels in exactly a straight line. The distance to the right depends on the distance the camera lens is away from the intended object. If the lens is 10 feet away or further, the user slides the guiding plate all the way to the far most right indicator on the scale. For distances around 7 feet, the user uses the 7 feet indicator which also the default “R” right position (a distance separation from left to right of 65 mm). Then the user snaps a right-eye view of the intended subject.

Depending on the camera being used, the user can either then develop the pictures and scan them, or download the stereo pair to a PC or printer and manipulate with a 3D stereo pair editing or mixing software or a professional photo editor to create the desired stereoscopic or anaglyph formats.

1. An ultra-slim-design stereoscopic plate apparatus comprising:
a slim plate design with a back-of-camera ridge support to maintain straight movement of the camera from left to right;
a means to support any size consumer digital, SLR, APS, Polaroid, point and shoot, disposable, or any other camera;
a means to keep the plate from prematurely sliding on top of a flat surface when in use, in the example shown we give a rubber or cork mat example;
a small guide indicator with a viewing window to track the distance between the left and right image to be captured and behaves as a Left or Right side support of the camera to better maintain straight positioning;
a 3D photography scale to guide the photographer and helps in the capture of quality stereo pairs of left and right photos;
a means to allow placement of a horizontal level vial if needed;
a means to add a tripod socket if needed;

2. The apparatus claim of 1 using the sliding guide by means of sliding it on the back ridge of the stereoscopic base plate to maintain both a back and side support for the camera to help make the angle of the lens perpendicular to the back ridge and help the camera to travel from left to right in a straight parallel line.

3. The apparatus claim of 2 in an ultra slim design that's very lightweight and easy to carry and does not require a means to attach a camera directly to the adapter making it extremely simple to use and allows any camera that is equipped with a tripod socket or not to be used.

4. The apparatus claim of 3 including means to position camera to a left or right first position to capture the first pair of a stereo pair of images for the purposes of future viewing in various three dimensional formats. The camera is simply placed on the plate with the back of the camera set snugly against the sliding guide. Then said sliding guide along with the placed camera are slid together to a desired position, and then stopped to allow the user to capture a first photograph, and then both slid to the next desirable position to take a second photograph. (a mirror version of the apparatus can also work in the opposite direction).

5. Said apparatus claim of 1 if first time slim design created to help beginners and novice users to quickly capture quality stereoscopic photographs freely using a single camera without the need to attach a camera to any apparatus.

6. Said apparatus claim of 1 is intended for use with any camera, digital, SLR, APS, point and shoot, Polaroid, PC camera, or any other camera in all its mode of operations in including but not limited to various macro, zoom or wide angle modes or attachable lenses.

7. Said apparatus claim of 1 is the simplest way to capture quality stereoscopic photographs. This is especially important, for it makes an affordable product available to novices including children.
